(19) United States
(12) Patent Application Publication
(10) Pub. No.: US 2015/0106285 A1
(43) Pub. Date: Apr. 16, 2015

(54) MOOD-BASED ANALYTICS FOR COLLABORATIVE PLANNING OF A GROUP TRAVEL ITINERARY

(71) Applicant: LENOVO ENTERPRISE SOLUTIONS (SINGAPORE) PTE. LTD., NEW TECH PARK (SG)

(72) Inventors: Jean Chu, Englewood Cliffs, NJ (US); Susan L. Diamond, Poughkeepsie, NY (US); William L. Fang, Astoria, NY (US); Peter B. Hom, Oakland Gardens, NY (US); Raghunandan Hulgundi, Highland, NY (US); Jenny S. Li, Danbury, CT (US); Jing-Na Yuan, Hopewell Junction, NY (US)

(21) Appl. No.: 14/055,488

(22) Filed: Oct. 16, 2013

(51) Int. Cl. G06Q 50/14; G06Q 10/00

(52) U.S. Cl. CPC G06Q 50/14; G06Q 10/00
USPC 705/319

(57) ABSTRACT

A method for providing mood-based analytics for collaborative travel planning for a group containing one or more group member includes receiving a priority, a target happiness index, and mood-based input for each group member. A target group happiness index is calculated based on an aggregate of the target happiness indexes weighted by the priority for each group member. A current group happiness index is calculated based on an aggregate of the mood-based input weighted by the priority for each group member. The activity preferences for the group are determined based on the aggregate of the mood-based input weighted by the priority for each group member. External environmental data that influences the current group happiness and the activity preferences is collected. A group itinerary based on the current group happiness index, the activity preferences for the group, and the external environmental data is generated to meet the target group happiness index.

### BACKGROUND

The present invention relates generally to creating a travel itinerary, and more specifically, to providing mood-based analytics for collaborative planning of a group travel itinerary.

Planning a trip for a group of people, such as a family or group of friends, may be time-consuming and complex due to many moving parts and variables. In preparation for the trip, a traveler typically creates a travel itinerary by conducting research about possible destinations, various travel routes, different lodging options, restaurant options, transportation options, and various activities for the duration of the trip. Contemporary travel applications provide one-stop automation to assist travelers in building a travel itinerary. The automated travel itinerary, however, is typically pre-planned without considering or prioritizing the moods, feelings, or preferences of multiple travelers in the group. Moreover, existing travel applications do not consider unexpected changes in transportation, lodging, travel times, weather, and the travel group's energy levels and disposition during the trip, which may impact the pre-planned itinerary.

### BRIEF SUMMARY

According to an embodiment of the present invention, a method for mood-based analytics for collaborative travel planning for a group containing one or more group member is provided. The method includes receiving a priority, a target happiness index, and mood-based input for each group member. A target group happiness index is calculated based on an aggregate of the target happiness indexes weighted by the priority for each group member. Additionally, a current group happiness index calculated based on an aggregate of the mood-based input weighted by the priority for each group member. The activity preferences for the group is then determined based on the aggregate of the mood-based input weighted by the priority for each group member. External environmental data that influences the current group happiness and the activity preferences is then collected. A group itinerary based on the current group happiness index, the activity preferences for the group, and the external environmental data is then generated to meet the target group happiness index.

According to another embodiment of the present invention, a system for mood-based analytics for collaborative travel planning for a group containing one or more group member is provided. The system includes a computer processor and logic executable by the computer processor. The logic is configured to implement a method. The method includes receiving a priority, a target happiness index, and mood-based input for each group member. A target group happiness index is calculated based on an aggregate of the target happiness indexes weighted by the priority for each group member. Additionally, a current group happiness index calculated based on an aggregate of the mood-based input weighted by the priority for each group member. The activity preferences for the group is then determined based on the aggregate of the mood-based input weighted by the priority for each group member. External environmental data that influences the current group happiness and the activity preferences is then collected. A group itinerary based on the current group happiness index, the activity preferences for the group, and the external environmental data is then generated to meet the target group happiness index.

According to a further embodiment of the present invention, a computer program product for mood-based analytics for collaborative travel planning for a group containing one or more group member is provided. The computer program product includes a storage medium having computer-readable program code embodied thereon, which when executed by a computer processor, causes the computer processor to implement a method. The method includes receiving a priority, a target happiness index, and mood-based input for each group member. A target group happiness index is calculated based on an aggregate of the target happiness indexes weighted by the priority for each group member. Additionally, a current group happiness index calculated based on an aggregate of the mood-based input weighted by the priority for each group member. The activity preferences for the group is then determined based on the aggregate of the mood-based input weighted by the priority for each group member. External environmental data that influences the current group happiness and the activity preferences is then collected. A group itinerary based on the current group happiness index, the activity preferences for the group, and the external environmental data is then generated to meet the target group happiness index.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a computer system according to an embodiment;

FIG. 2 depicts a block diagram of a system for providing mood-based analytics for collaborative planning of a group travel itinerary according to an embodiment;

FIG. 3 depicts an example of a mood profile of a group member according to an embodiment;

FIG. 4 depicts an example of an activity list according to an embodiment; and

FIG. 5 depicts a process for providing mood-based analytics for collaborative planning of a group travel itinerary according to an embodiment.

### DETAILED DESCRIPTION

Embodiments disclosed herein include mood-based analytics for collaborative travel planning for a group containing one or more group member is provided. An aspect of embodiments includes receiving a priority, a target happiness index, and mood-based input for each group member. A target group happiness index is calculated based on an aggregate of the target happiness indexes weighted by the priority for each group member. Additionally, a current group happiness index calculated based on an aggregate of the mood-based input weighted by the priority for each group member. The activity preferences for the group is then determined based on the aggregate of the mood-based input weighted by the priority for each group member. External environmental data that influences the current group happiness and the activity preferences is then collected. A group itinerary based on the current group happiness index, the activity preferences for the group, and the external environmental data is then generated to meet the target group happiness index.

Existing travel itinerary planners typically only consider places of interest, budget, and duration, thus lacking group decision parameters including a traveler's mood, a traveler's priority within a group, and external environmental factors. In other words, contemporary planners do not consider the preferences of multiple travelers while planning a trip for a group of travelers. In addition, contemporary travel itinerary planners are not iterative and only provide one-time planning.

Embodiments disclosed herein provide a feedback loop capturing each member's experience during the trip and modifies the group itinerary accordingly throughout the trip. In other words, embodiments define and create a group itinerary that would facilitate the fulfillment of a desired group experience, which can be dynamically adjusted during the travel execution. Embodiments focus on planning activities for a group of travelers while considering the individual feelings of all group members during the trip. A detailed day route and itinerary may be generated for an individual or based on the collective mood of the members involved in the trip (e.g., friends and family). Embodiments also evaluate and weigh the risk of external influences which could positively or negatively affect the proposed itinerary by monitoring feeds from physical environments as well as other potential information gathered from social media and news sites.

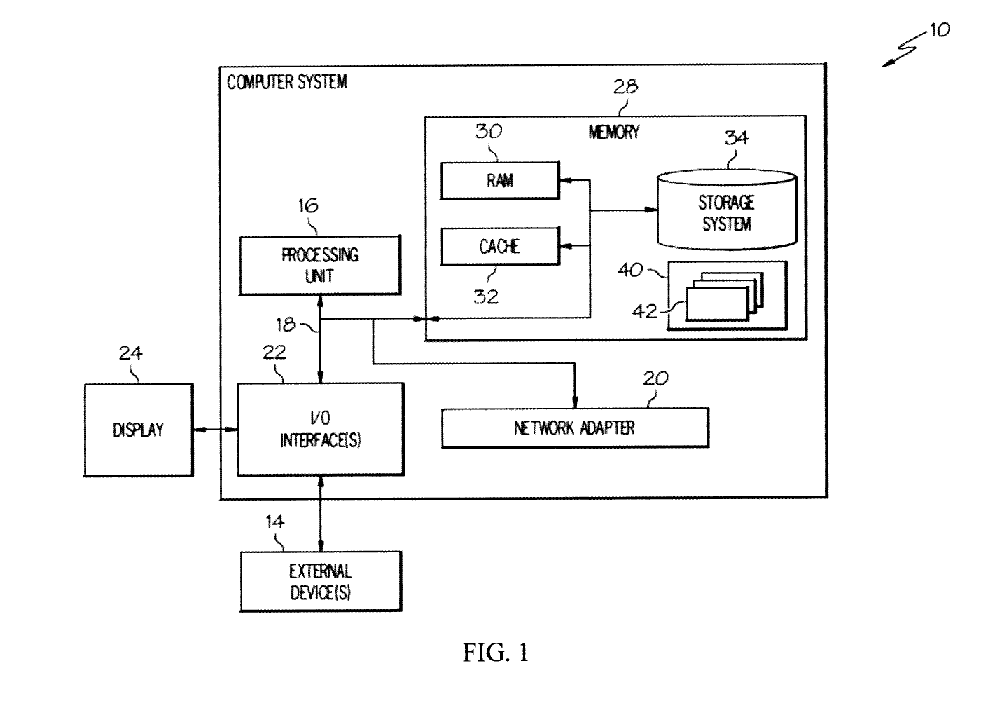

Referring now to FIG. 1, a block diagram of a computer system 10 suitable for providing mood-based analytics for collaborative planning of a group travel itinerary according to exemplary embodiments is shown. Computer system 10 is only one example of a computer system and is not intended to suggest any limitation as to the scope of use or functionality of embodiments described herein. Regardless, computer system 10 is capable of being implemented and/or performing any of the functionality set forth hereinabove.

Computer system 10 is operational with numerous other general purpose or special purpose computing system environments or configurations. Examples of well-known computing systems, environments, and/or configurations that may be suitable for use with computer system 10 include, but are not limited to, personal computer systems, server computer systems, thin clients, thick clients, cellular telephones, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 10 may be described in the general context of computer system-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media including memory storage devices.

As shown in FIG. 1, computer system 10 is shown in the form of a general-purpose computing device, also referred to as a processing device. The components of computer system may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that is accessible by computer system/server 10, and it includes both volatile and non-volatile media, removable and non-removable media.

System memory 28 can include computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18. It should be understood that although not shown, other hardware and/or software components could be used in conjunction with computer system 10. Examples include, but are not limited to: microcode, device drivers, redundant processing units, external disk drive arrays, RAID systems, tape drives, and data archival storage systems, etc.

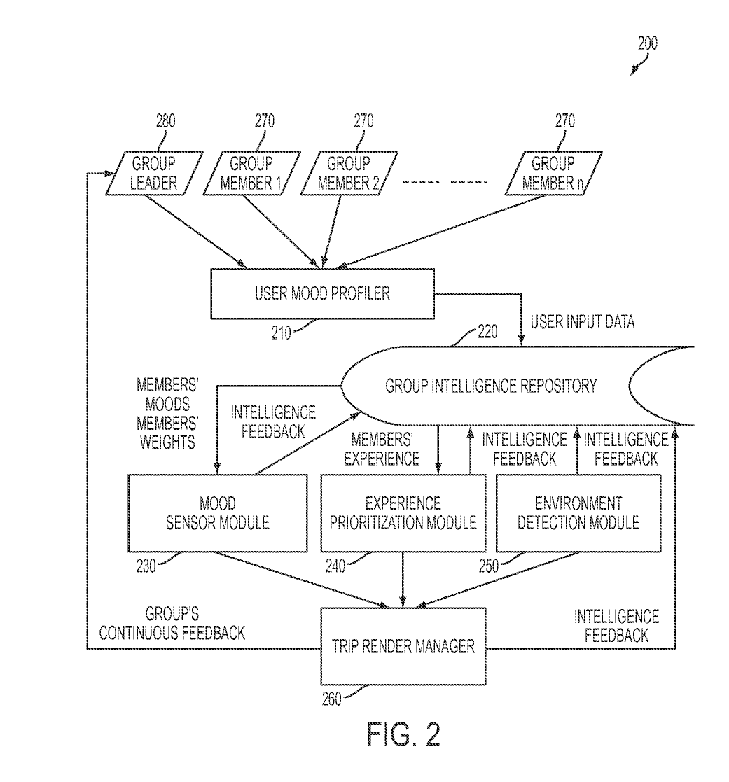

With reference to FIG. 2, a block diagram of a system 200 for providing mood-based analytics for collaborative planning of a group travel itinerary according to an embodiment is shown. The system 200 may include a user mood profiler 210, a group intelligence repository 220, a mood sensor module 230, an experience prioritization module 240, an environment detection module 250, and a trip render manager 260.

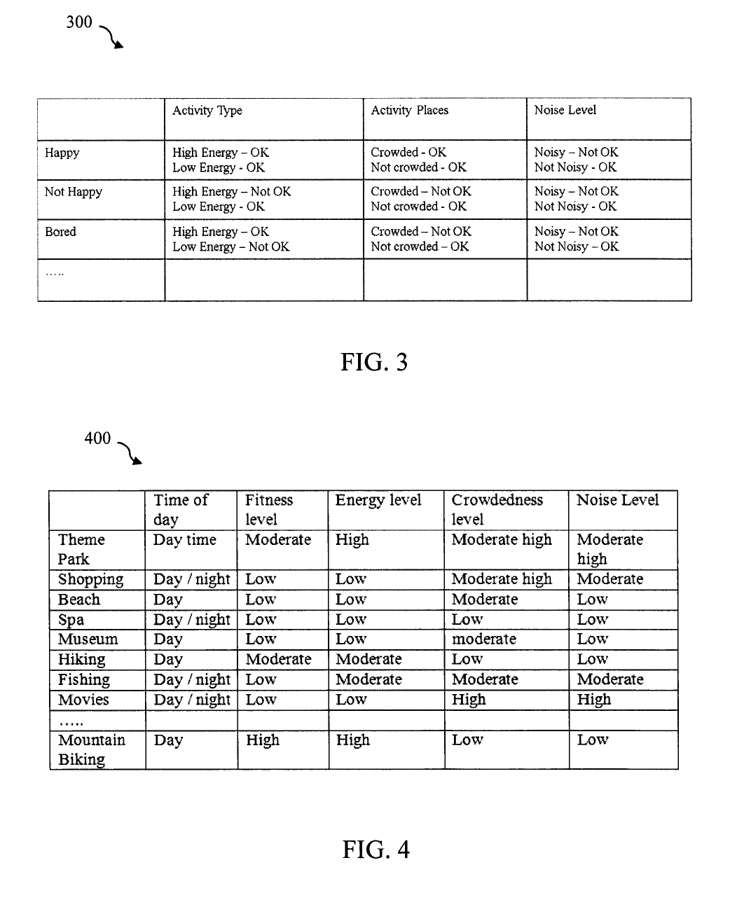

The user mood profiler 210 of an embodiment is a user interface component that receives input from group members. Particularly, the user mood profiler 210 receives a priority weight value for each group member 270 as input from a designated group leader 280 on behalf of the entire group or from individual group members. A target happiness index is also received from each individual member. All the members' target happiness indexes are then aggregated and computed depending on the assigned weight value of each group member 270. For example, a group may include a couple and their sixteen year old daughter. The trip is to celebrate her sixteenth birthday. Accordingly, the priority of the daughter's happiness index may carry more weight than the wife's or the husband's. A target group happiness index calculated with the daughter's priority weight may aim to meet the daughter's target happiness index. The user mood profiler 210 also receives mood-based input from each group member 270. The mood-based input may include, but is not limited to, a current mood input from each group member 270 and an activity experience input from each group member 270. A current mood may include, but is not limited to, a selected one of happy, not happy, bored, ready for adventure, tired, grumpy, ready for sport, ready for relaxing, bad mood, ready to party, angry, ready for anything, and the like. Additionally, the user mood profiler 210 may receive input regarding each group member's name, age, interests, fitness level, and travel preferences according to an embodiment. The user mood profiler 210 stores the group leader and/or group member data in the group intelligence repository 220 according to an embodiment. An example of a mood profile 300 of a group member of an embodiment is generally shown in FIG. 3.

The group intelligence repository 220 of an embodiment is a database that stores and aggregates members' target happiness indexes, priority weights, moods and past experiences. Additionally, the group intelligence repository 220 of an embodiment stores and aggregates a target group happiness index that is determined by the members' target happiness indexes and priority weights and a current group's happiness index based on the continuous feedback of members' current mode and their respective priority weight. The repository is a central module that interacts with the mood sensor module 230, the experience prioritization module 240, and environment detection module 250. The group intelligence repository 220 gathers intelligence feedback regarding characteristics of a successful and happy trip before, during, and after the trip to make dynamic itinerary recommendations based on the feedback according to an embodiment.

The mood sensor module 230 of an embodiment aggregates, measures, and stores real-time moods and behaviors of each group member 270. The mood sensor module 230 then computes the current group's happiness index weighted by a priority assigned by the group leader 280. Output from the mood sensor module 230 may be sent to the trip render manager 260 for real-time implementation and the group intelligence repository for analysis 220 according to an embodiment.

The experience prioritization module 240 of an embodiment collects rules, objectives, and an activity list for the group to maximize the current happiness index score. An example of an activity list 400 of an embodiment is generally shown in FIG. 4. According to an embodiment, the experience prioritization module 240 analyzes each member's past activity experiences and/or preferences and prioritizes a list of suggested activities based on the aggregated mood-based input for the group. Output from the experience prioritization module 240 may be sent to trip render manager 260 for real-time implementation and to the group intelligence repository 220 for analysis.

The environment detection module 250 of an embodiment collects, measures, and stores real-time external environment information (e.g., traffic, weather, social media networks, and culture information) that may influence the trip. Output from the environment detection module 250 is sent to trip render manager 260 for real-time implementation and the group intelligence repository 220 for further analysis according to an embodiment. According to an embodiment, real-time travel advice may be analyzed and extracted from each member's social networks.

The trip render manager 260 of an embodiment analyzes inputted mood, environment, and priority factors in real-time to recommend one or more group itinerary roadmaps that meet the target group happiness index and/or achieves the highest group happiness index possible. A group leader 280 and/or group member 270 may then select one of the recommended group travel itineraries and provide continuous feedback to the user mood profiler 210 during the trip.

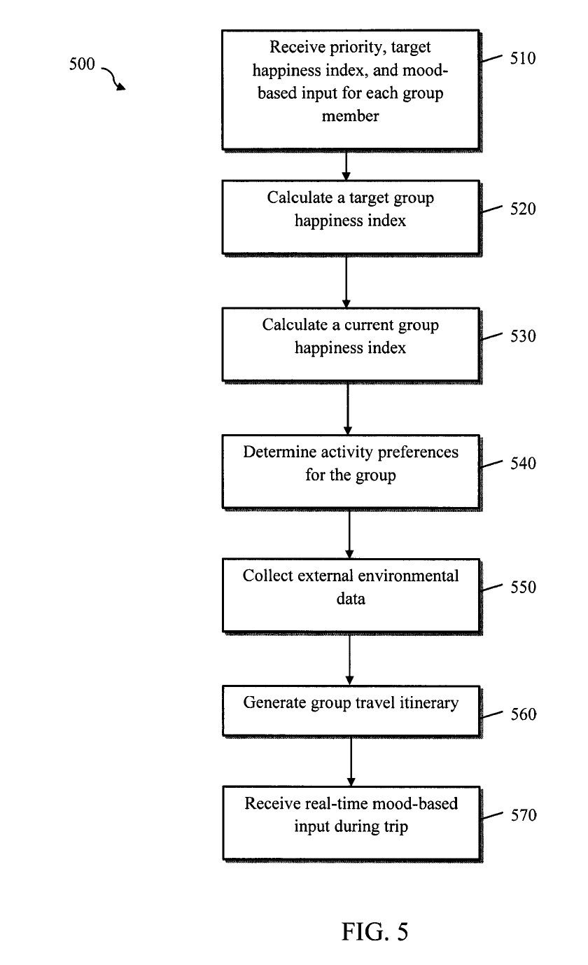

With reference to FIG. 5, a process 500 performed by an embodiment of processor 16 of computer system 10 is generally shown. As shown in FIG. 5, the process 500 provides mood-based analytics for collaborative planning of a group travel itinerary according to an embodiment. A group of an embodiment may include one or more group members 270. One or more of the group members may be appointed as the group leader 280 according to an embodiment.

At block 510, a priority weight, a target happiness index, and mood-based input are received for each group member 270 as input in the user mood profiler 210 according to an embodiment. The priority for each group member may be assigned a different value based on a time of day according to an embodiment. For example, a group member may be assigned a value of ‘4’ on a scale from 1-5 (‘1’ being lowest priority and ‘5’ being highest priority) in the morning hours and assigned a value of ‘2’ in the evening hours. The mood-based input for each group member 270 may include, but is not limited to, a current mood input from each group member and a past travel activity experience input from each group member. The user mood profiler 210 stores all the user input data into group intelligence repository 220.

At block 520, a target group happiness index is calculated based on the aggregate of the target happiness indexes and the priority for each group member according to an embodiment. At block 530, a current group happiness index is calculated based on an aggregated mood-based input and the priority for each group member 270 according to an embodiment. The mood sensor module 230 aggregates all mood-based input data and calculates the current group's happiness index using the priority weights assigned to each group member 270.

At block 540, activity preferences for the group are determined based on the aggregated mood-based input according to an embodiment. The experience prioritization module 240 uses each member's experience data to derive a prioritized list of activities according to an embodiment.

At block 550, external environmental data collected. The external data includes data that may influence the aggregated mood-based input and the activity preferences according to an embodiment. The external environmental data may include a selected one or more from traffic conditions, weather conditions, social media alerts, and culture information. The environment detection module 250 discovers and collects external environmental factors from various data feeds including, but not limited to, weather channels, traffic reporting channels, and social networking sites that may impact the pleasure of a trip.

At block 560, one or more initial group itineraries are generated based on the current group happiness, the activity preferences, and the external environmental data such that the target group happiness index is met according to an embodiment. The generating of the group travel itinerary further includes mapping the aggregated mood-based input into suggested activities for a trip, computing routes to the suggested activities of the trip, and recommending trip routes that meet the target group happiness index. The trip render manager 260 maps the aggregated mood-based input from the group members into suggested activities, computes routes based on environmental factors, and recommends day trip routes that meet the target group happiness index. The group leader 280 and/or group member 270 may then select a recommended route and start the trip.

According to an embodiment, if there is a conflict in selecting an activity that maps to all the moods of the group members 270, the priority weight assigned to each group member 270 may be used to resolve the situation. Based upon the priority parameters, the trip render manager 260 regenerates and/or adjusts the initial itinerary and recommends a revised travel itinerary.

At block 570, mood-based input from a group member may be received in real-time during a trip according to an embodiment. Accordingly, the group itinerary may be dynamically adjusted or modified to meet the target group happiness index based on the new, real-time feedback from the group members during the trip. In other words, according to an embodiment, continuous group feedback may be used to generate new routes as needed. At any point of time in the trip, any group member 270 can provide feedback to the user mood profiler 210 about his or her mood and experience about the trip. The group leader 280 may also modify the target group happiness index and assign a different priority to group members 270. This continuous feedback loop dynamically integrates the internal priorities and new external shocks to produce an optimal itinerary recommendation in real-time.

According to an embodiment, each group member 270 has a different way of handling his mood. An embodiment establishes a mood profile for each member of the trip, as generally shown in FIG. 3. For example, John may be open to trying out new things if he is in happy mood, but doesn't feel like doing a lot of activities if he is in bad mood. His wife Mary may always be in a happy mood. If John and Mary are expecting to visit four or five destination in crowded areas, John may not feel like visiting all these locations when he is in a bad mood. According to another embodiment, some group members on the same trip may have their opinion weighted higher than others. For example, if John, Mary, their kids and their grandma are on a trip to celebrate grandma's birthday, an embodiment would prioritize grandma's moods and suggest activities that grandma would like to do.

The mood profile of each group member 270 may map to a list of suggested activities that is appropriate for the group members 270 according to an embodiment. Before the group members 270 carry out a trip schedule, group member 270 may enter their moods individually. An embodiment will assess if the current itinerary is appropriate for the group members 270 based on their moods. If not, a new itinerary may be generated.

Technical effects and benefits include providing mood-based analytics for collaborative planning of a group travel itinerary. Embodiments allow multiple group members on the same trip to input their current mood for group based travel planning. Embodiments further allow prioritization of certain group member's mood over others. Moreover, embodiments disclosed provide iterative mood-based analytics for collaborative planning of a group travel itinerary. Group members may input their mood anytime during a trip. Accordingly, a new calibration or assessment of an itinerary for the remaining trip will be generated based on real-time input of the users' mood.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for providing mood-based analytics in collaborative travel planning for a group containing one or more group members, comprising:
receiving, by a processing device, a priority for each group member;
receiving a target happiness index for each group member;
receiving mood-based input for each group member;
calculating a target group happiness index based on an aggregate of the target happiness indexes weighted by the priority for each group member;
calculating a current group happiness index based on an aggregate of the mood-based input weighted by the priority for each group member;
determining activity preferences for the group based on the aggregate of the mood-based input weighted by the priority for each group member;
collecting external environmental data that influences the current group happiness and the activity preferences; and
generating a group itinerary based on the current group happiness index, the activity preferences for the group, and the external environmental data that meets the target group happiness index.

2. The computer-implemented method of claim 1, wherein the receiving of mood-based input further comprises:
receiving a current mood input from each group member prior to or during a trip; and
receiving an activity experience input from each group member prior to or during the trip.

3. The computer-implemented method of claim 1, wherein the priority for each group member is assigned according to a time of day.

4. The computer-implemented method of claim 1, wherein the generating of the group itinerary further comprises:
mapping the aggregate of the mood-based input into suggested activities for a trip;
computing routes to the suggested activities of the trip; and
recommending travel routes that meet the target group happiness index.

5. The computer-implemented method of claim 1, wherein the method further comprises:
receiving mood-based input from a group member in real-time during a trip; and
adjusting the group itinerary dynamically to meet the target group happiness index.

6. The computer-implemented method of claim 1, wherein the external environmental data comprises a selected one or more from traffic conditions, weather conditions, social media alerts, and culture information.

7. A computer system for providing mood-based analytics in collaborative travel planning for a group containing one or more group members, comprising:
a memory having computer readable computer instructions; and
a processor for executing the computer readable instructions to perform a method comprising:
receiving a priority for each group member;
receiving a target happiness index for each group member;
receiving mood-based input for each group member;
calculating a target group happiness index based on an aggregate of the target happiness indexes weighted by the priority for each group member;
calculating a current group happiness index based on an aggregate of the mood-based input weighted by the priority for each group member;
determining activity preferences for the group based on the aggregate of the mood-based input weighted by the priority for each group member;
collecting external environmental data that influences the current group happiness and the activity preferences; and
generating a group itinerary based on the current group happiness index, the activity preferences for the group, and the external environmental data that meets the target group happiness index.

8. The computer system of claim 7, wherein the receiving of mood-based input further comprises:
receiving a current mood input from each group member prior to or during a trip; and
receiving an activity experience input from each group member prior to or during the trip.

9. The computer system of claim 7, wherein the priority for each group member is assigned according to a time of day.

10. The computer system of claim 7, wherein the generating of the group itinerary further comprises:
mapping the aggregate of the mood-based input into suggested activities for a trip;
computing routes to the suggested activities of the trip; and
recommending travel routes that meet the target group happiness index.

11. The computer system of claim 7, wherein the method further comprises:
receiving mood-based input from a group member in real-time during a trip; and
adjusting the group itinerary dynamically to meet the target group happiness index.

12. The computer system of claim 7, wherein the external environmental data comprises a selected one or more from traffic conditions, weather conditions, social media alerts, and culture information.

13. A computer program product for providing mood-based analytics in collaborative travel planning for a group containing one or more group members, the computer program product comprising:
a computer readable storage medium having program code embodied therewith, the program code executable by a processor for:
receiving a priority for each group member;
receiving a target happiness index for each group member;
receiving mood-based input for each group member;
calculating a target group happiness index based on an aggregate of the target happiness indexes weighted by the priority for each group member;
calculating a current group happiness index based on an aggregate of the mood-based input weighted by the priority for each group member;
determining activity preferences for the group based on the aggregate of the mood-based input weighted by the priority for each group member;
collecting external environmental data that influences the current group happiness and the activity preferences; and
generating a group itinerary based on the current group happiness index, the activity preferences for the group, and the external environmental data that meets the target group happiness index.

14. The computer program product of claim 13, wherein the receiving of mood-based input further comprises:
receiving a current mood input from each group member prior to or during a trip; and
receiving an activity experience input from each group member prior to or during the trip.

15. The computer program product of claim 13, wherein the priority for each group member is assigned according to a time of day.

16. The computer program product of claim 13, wherein the generating of the group itinerary further comprises:
mapping the aggregate of the mood-based input into suggested activities for a trip;
computing routes to the suggested activities of the trip; and
recommending travel routes that meet the target group happiness index.

17. The computer program product of claim 13, wherein the method further comprises:
receiving mood-based input from a group member in real-time during a trip; and
adjusting the group itinerary dynamically to meet the target group happiness index.

18. The computer program product of claim 13, wherein the external environmental data comprises a selected one or more from traffic conditions, weather conditions, social media alerts, and culture information.
